(19) United States
(12) Patent Application Publication
(10) Pub. No.: US 2025/0391920 A1
(43) Pub. Date: Dec. 25, 2025

(54) ELECTROLYTES FOR LITHIUM METAL BATTERIES

(71) Applicant: GM GLOBAL TECHNOLOGY OPERATIONS LLC, DETROIT, MI (US)

(72) Inventors: Nathaniel Hardin, Farmington Hills, MI (US); Yifan Zhao, Troy, MI (US); Fang Dai, Troy, MI (US)

(21) Appl. No.: 18/747,528

(22) Filed: Jun. 19, 2024

(51) Int. Cl. H01M 10/0569; B60L 50/60; H01M 10/0525; H01M 10/0568; H01M 10/0585

(52) U.S. Cl. CPC H01M 10/0569; H01M 10/0525; H01M 10/0568; H01M 10/0585; B60L 50/60; H01M 2220/20; H01M 2300/0034; H01M 2300/0037

(57) ABSTRACT

Aspects of the disclosure include lithium metal batteries having fluorinated diacyl acetamides as the electrolyte solvent and methods of manufacturing the same. An exemplary vehicle includes an electric motor and a battery pack electrically coupled to the electric motor. The battery pack includes a battery cell that includes an anode current collector, an anode active material layer in direct contact with a surface of the anode current collector, a cathode current collector, a cathode active material layer in direct contact with a surface of the cathode current collector, and a liquid electrolyte over the cathode active material layer. The liquid electrolyte includes a lithium salt dissolved in an organic solvent. The organic solvent includes a fluorinated diacyl acetamide having an N-acetyl group coupled to a first functional group, a second functional group, and a third functional group.

### INTRODUCTION

The present disclosure relates to battery cell manufacturing, and particularly to the use of fluorinated diacyl acetamides as the electrolyte solvent for lithium metal batteries.

Lithium metal cells, also known as lithium metal batteries, are a type of rechargeable battery technology that have gained significant attention due to their high theoretical energy densities, meaning these types of batteries can potentially store more energy per unit mass or volume than conventional lithium-ion batteries. The anode (negative electrode) in a lithium metal cell is typically composed of metallic lithium, which has a relatively high specific capacity (e.g., 3,860 mAh/g) and a relatively low electrochemical potential (e.g., −3.04 V as measured against a hydrogen electrode). The cathode (positive electrode) can be made of various materials, such as lithium transition metal oxides (e.g., LiCoO₂, LiNiMnCoO₂, etc.), lithium metal phosphates (e.g., LiFePO₄), or other suitable compounds that can reversibly intercalate and deintercalate lithium ions.

The electrodes in a lithium metal cell are separated by an electrolyte, which is typically a lithium salt dissolved in an organic solvent or a solid polymer electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium metal atoms at the anode oxidize and release electrons, which flow through the external circuit to the cathode, providing electrical energy to power a device. At the same time, lithium ions migrate from the anode through the electrolyte and intercalate into the cathode material. During charging, this process is reversed, with lithium ions being extracted from the cathode and deposited back onto the anode as metallic lithium.

### SUMMARY

In one exemplary embodiment a vehicle includes an electric motor and a battery pack electrically coupled to the electric motor. The battery pack includes a battery cell that includes an anode current collector, an anode active material layer in direct contact with a surface of the anode current collector, a cathode current collector, a cathode active material layer in direct contact with a surface of the cathode current collector, and a liquid electrolyte over the cathode active material layer. The liquid electrolyte includes a lithium salt dissolved in an organic solvent. The organic solvent includes a fluorinated diacyl acetamide having an N-acetyl group coupled to a first functional group, a second functional group, and a third functional group.

In addition to one or more of the features described herein, in some embodiments, the fluorinated diacyl acetamide includes one of N,N-dimethyl-2,2,2-trifluoroacetamide (FDMA) or N,N-diethyl-2,2,2-trifluoroacetamide (FDEA).

In some embodiments, the lithium salt includes at least one of lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), or lithium bis(pentafluoroethanesulfonyl)imide (LiBETI).

In some embodiments, the first functional group includes a fluorocarbon of at least one of CF₃, CF₂, CF, C₂F, C₂F₂, C₂F₃, C₂F₄, C₂F₅, or C₃F₇. In some embodiments, the second functional group and the third functional group each includes, separately, at least one of a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃).

In some embodiments, a separator is formed between the anode active material layer and the cathode active material layer. In some embodiments, the liquid electrolyte partially penetrates the separator.

In some embodiments, the liquid electrolyte further includes a carbonate solvent having a concentration in the electrolyte of less than 10 percent by weight.

In another exemplary embodiment a battery cell includes an anode current collector, an anode current collector, an anode active material layer in direct contact with a surface of the anode current collector, a cathode current collector, a cathode active material layer in direct contact with a surface of the cathode current collector, and a liquid electrolyte over the cathode active material layer. The liquid electrolyte includes a lithium salt dissolved in an organic solvent. The organic solvent includes a fluorinated diacyl acetamide having an N-acetyl group coupled to a first functional group, a second functional group, and a third functional group.

In some embodiments, the fluorinated diacyl acetamide includes one of FDMA or FDEA.

In some embodiments, the lithium salt includes at least one of LiPF₆, LiTFSI, LiBOB, LiDFOB, LiFSI, LiTf, LiBF₄, LiNO₃, or LiBETI.

In some embodiments, the first functional group includes a fluorocarbon of at least one of CF₃, CF₂, CF, C₂F, C₂F₂, C₂F₃, C₂F₄, C₂F₅, or C₃F₇. In some embodiments, the second functional group and the third functional group each includes, separately, at least one of a methyl group, an ethyl group, a propyl group, an isopropyl group, a butyl group, a sec-butyl group, a tert-butyl group, an isobutyl group, a pentyl group, an isopentyl group, a neopentyl group, a hexyl group, a 2-methylpentyl group, a 3-methylpentyl group, a 2,2-dimethylbutyl group, a 2,3-dimethylbutyl group, a heptyl group, an octyl group, a nonyl group, a decyl group, an undecyl group, or a dodecyl group.

In some embodiments, a separator is formed between the anode active material layer and the cathode active material layer. In some embodiments, the liquid electrolyte partially penetrates the separator.

In some embodiments, the liquid electrolyte further includes a carbonate solvent having a concentration in the electrolyte of less than 10 percent by weight.

In yet another exemplary embodiment a method can include forming a battery cell by forming an anode current collector, forming an anode active material layer in direct contact with a surface of the anode current collector, forming a cathode current collector, forming a cathode active material layer in direct contact with a surface of the cathode current collector, and forming a liquid electrolyte over the cathode active material layer. The liquid electrolyte includes a lithium salt dissolved in an organic solvent. The organic solvent includes a fluorinated diacyl acetamide having an N-acetyl group coupled to a first functional group, a second functional group, and a third functional group.

In some embodiments, the fluorinated diacyl acetamide includes one of FDMA or FDEA.

In some embodiments, the lithium salt includes at least one of LiPF₆, LiTFSI, LiBOB, LiDFOB, LiFSI, LiTf, LiBF₄, LiNO₃, or LiBETI.

In some embodiments, the first functional group includes a fluorocarbon of at least one of CF₃, CF₂, CF, C₂F, C₂F₂, C₂F₃, C₂F₄, C₂F₅, or C₃F₇. In some embodiments, the second functional group and the third functional group each includes, separately, at least one of a methyl group, an ethyl group, a propyl group, an isopropyl group, a butyl group, a sec-butyl group, a tert-butyl group, an isobutyl group, a pentyl group, an isopentyl group, a neopentyl group, a hexyl group, a 2-methylpentyl group, a 3-methylpentyl group, a 2,2-dimethylbutyl group, a 2,3-dimethylbutyl group, a heptyl group, an octyl group, a nonyl group, a decyl group, an undecyl group, or a dodecyl group.

In some embodiments, a separator is formed between the anode active material layer and the cathode active material layer. In some embodiments, the liquid electrolyte partially penetrates the separator.

In some embodiments, the liquid electrolyte further includes a carbonate solvent having a concentration in the electrolyte of less than 10 percent by weight.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 3 is a chemical structure of a fluorinated diacyl acetamide for use as a solvent in an electrolyte in accordance with one or more embodiments;

FIG. 4A is a chemical structure of a fluorinated diacyl acetamide for use as a solvent in an electrolyte in accordance with one or more embodiments;

FIG. 4B is a chemical structure of a fluorinated diacyl acetamide for use as a solvent in an electrolyte in accordance with one or more embodiments;

FIG. 5A is an example chemistry for modifying ethers for different fluorination content in accordance with one or more embodiments;

FIGS. 5B to 5I are example ether compounds having different fluorination content in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of a final integrated device (e.g., a battery). A current collector typically includes a sheet of conductive material (e.g., aluminum foil) to which an active electrode material is attached. An energy storage system such as a battery cell or pouch can include a number of stacked anode current collectors and cathode current collectors, an active material(s) dispersed or otherwise situated on the current collectors, and a sufficient number of separators to prevent shorts between the anode current collectors and cathode current collectors. Thus, in many electrode configurations there is a clear separation between anode and cathode, and each electrode serves a specific function, with electrons flowing from the anode to the cathode through an external circuit.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Lithium metal cells, for example, are an increasingly relied upon rechargeable battery technology. Lithium metal cells have the potential to offer significantly higher energy densities as compared to conventional lithium-ion batteries, making them attractive for applications that require high energy storage capacity, such as electric vehicles and grid-scale energy storage systems. In particular, lithium metal has a very high theoretical specific capacity of 3,860 mAh/g, which translates to a relatively higher energy density than found in conventional lithium-ion batteries. Moreover, lithium metal has a low electrochemical potential (−3.04 V as compared to standard hydrogen electrode), which results in a higher cell voltage when paired with suitable cathode materials. The potentially higher specific capacities and higher voltages can lead to batteries having improved energy efficiency and reduced heat generation.

Challenges remain, however, in designing and manufacturing lithium metal batteries. For example, one challenge for fabricating liquid-electrolyte type lithium metal batteries is the formation of a stable and robust solid-electrolyte interphase (SEI) layer on the lithium metal anode surface. The SEI layer is formed through the reductive decomposition of electrolyte components during the initial charging cycles and serves as a protective layer that prevents further electrolyte decomposition and lithium metal dendrite growth. However, the formation of a stable and robust SEI layer on the lithium metal anode surface is challenging due to the high reactivity of lithium metal and the continuous stripping and plating of lithium when cycling. This can lead to the continuous consumption of the electrolyte and the formation of an unstable SEI layer, which can compromise the battery's performance.

To address this issue, liquid-electrolyte type lithium metal batteries incorporate carbonate solvents to dissolve the lithium salts used in these types of batteries. One of the most widely used carbonate solvents (also referred to as an electrolyte additive) is fluoroethylene carbonate (FEC). FEC is a cyclic carbonate compound that has been shown to improve the stability and properties of the SEI layer on lithium metal anodes. When present in the electrolyte, FEC preferentially decomposes on the lithium metal surface, forming a more stable and flexible SEI layer that can better accommodate the volume changes associated with lithium plating and stripping during cycling. The inclusion of FEC in the electrolyte has been demonstrated to significantly improve the cycle life, coulombic efficiency, and reactivity of lithium metal batteries by mitigating issues such as dendrite growth, electrolyte decomposition, and lithium metal corrosion. Additionally, FEC has been found to enhance the compatibility of the electrolyte with other components, such as separators and cathode materials, further improving the overall performance of the battery system.

Unfortunately, the use of carbonate-based solvents in the liquid electrolytes of lithium metal batteries presents several drawbacks in terms of battery manufacturability, handling, and performance. For example, common carbonate solvents like dimethyl carbonate (DMC) operate over a relatively narrow temperature range, with DMC having a relatively low boiling point of around 90 degrees Celsius and a relatively high melting point of 2-4 degrees Celsius. A narrow temperature range natively limits the ability of lithium metal batteries to operate freely in arbitrary environments, particularly in harsh environments or applications with wide temperature variations, such as in electric vehicles or grid-scale energy storage systems. Moreover, the low boiling points and high vapor pressures of carbonate solvents increase the risk of leakage and vapor accumulation in the cells. Another drawback in using carbonate solvents is the relatively high concentration of carbonate required to improve the stability and properties of the SEI layer. In FEC-based battery cells, for example, FEC can make up to ¼ or ⅓ the total weight of the liquid electrolyte, increasing costs, manufacturing complexity, and handling requirements (e.g., long-term compatibility and stability are made more difficult as the level of carbonates increases in the electrolyte). Electrode compatibility is also a concern, as carbonate-based electrolytes exhibit compatibility issues with certain electrode materials, particularly high-voltage cathodes and some lithium metal anodes. These incompatibilities can lead to side reactions, capacity fading, and degradation of battery performance.

This disclosure introduces lithium metal batteries having fluorinated diacyl acetamides as the electrolyte solvent and methods of manufacturing the same. Rather than relying on (or solely on) carbonate solvents for improved SEI layer quality and stability, battery cells manufactured as described herein utilize fluorinated diacyl acetamides, such as triflourodiacylacetamide, as the major solvent in the electrolyte. Fluorinated diacyl acetamide-type solvents have been found to provide a similar performance as carbonates such as FEC at decreased carbonate contents. In some embodiments, the carbonate content is reduced below 10 percent by weight in the electrolyte, such as 1 to 4 percent FEC by weight. In some embodiments, the carbonate content is eliminated entirely (e.g., 0 percent by weight FEC in the electrolyte).

Reducing (or eliminating entirely) the carbonate content in lithium metal battery electrolytes directly addresses a number of known limitations in the use of carbonate-based solvents. For example, lithium metal batteries having trifluorodiacylacetamide-based electrolytes can support relatively high boiling point electrolyte formulations (e.g., boiling points in excess of 120 degrees Celsius) at reduced weight (e.g., ¼ to ⅓ percent by weight FEC is reduced to a few percent, or eliminated entirely). The result is a battery cell with a wider operational range and an electrolyte that is compatible with a wider range of electrode materials and less prone to leakage (and resulting vapor accumulation in the cells).

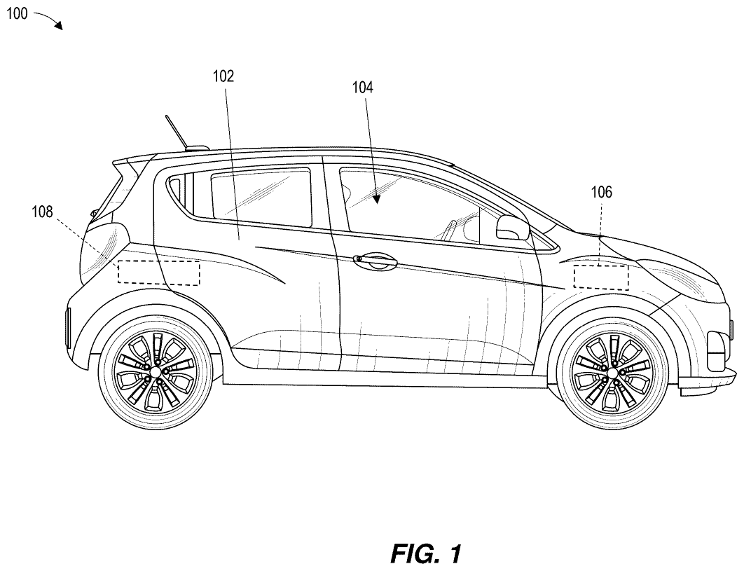

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

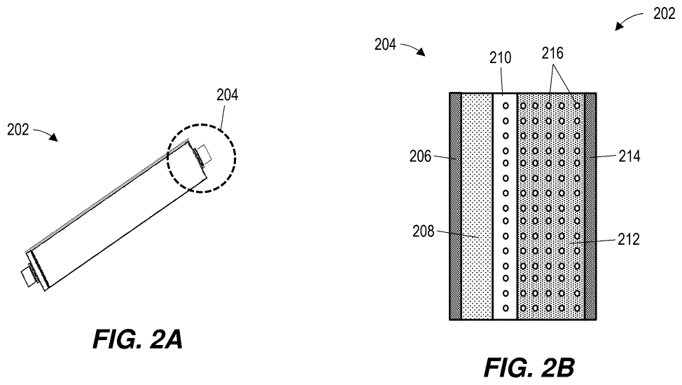

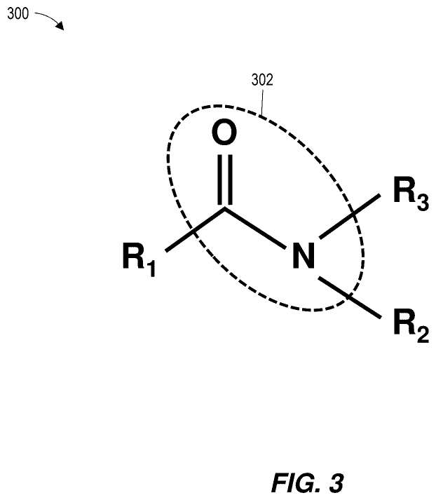

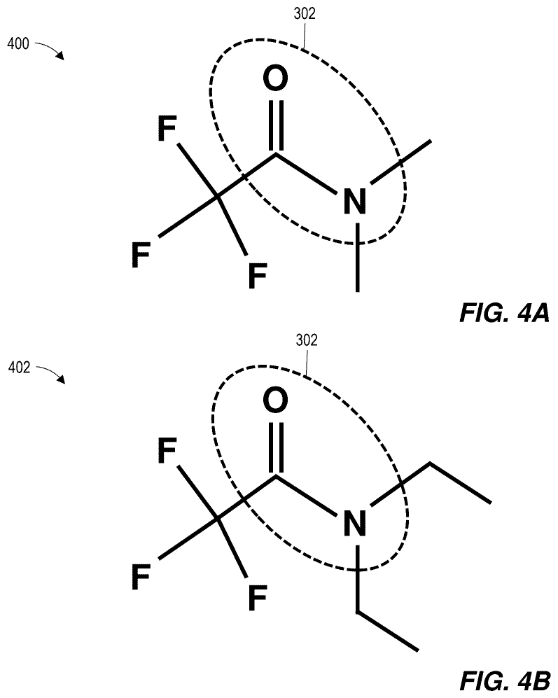

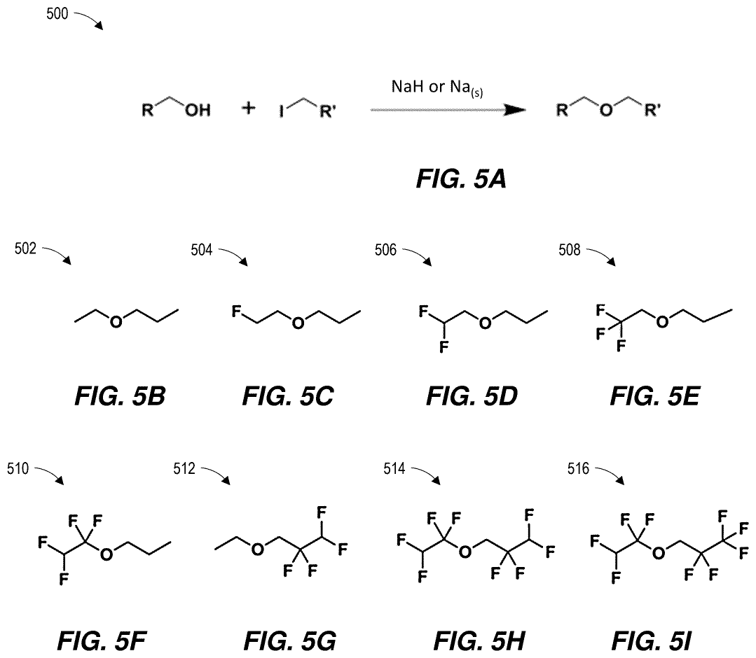

As will be detailed herein, the battery pack 108 includes one or more battery modules and/or battery pouches having lithium metal cell(s) with fluorinated diacyl acetamides as the electrolyte solvent. An example battery cell is shown in FIG. 2A. A detailed view of the battery cell of FIG. 2A is shown in FIG. 2B. Example fluorinated diacyl acetamides for use as the electrolyte solvent in a lithium metal battery are shown in FIGS. 3, 4A, and 4B. Example chemistries for modifying ethers for different fluorination content is shown in FIG. 5A.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. As shown in FIG. 2B, the battery cell 202 includes, from left to right, an anode current collector 206, an anode active material layer 208, a separator 210, a cathode active material layer 212, and a cathode current collector 214, configured and arranged as shown.

The anode current collector 206 and the cathode current collector 214 can be made of sheets or foils of conductive materials. For example, the cathode current collector 214 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 214 is made of aluminum foil. The anode current collector 206 can include, for example, copper foil and/or one or more graphene layers. In some embodiments, the anode current collector 206 is made of copper foil. Each layer thickness can be approximately 1 to 3 nm, although other thicknesses are within the contemplated scope of this disclosure.

The anode active material layer 208 and the cathode active material layer 212 can include various anode or cathode active materials, respectively. The anode active material layer 208 is not meant to be particularly limited, and can also include, for example, lithium metal, activated carbon powder, graphite, silicon, silicon-graphite composites, tin, tin oxide (SnO₂), lithium titanate (Li₄Ti₅O₁₂, LTO), and combinations thereof. In some embodiments, the composite anode layer 210 includes lithium metal and at least one of lithium lanthanum zirconate (Li₇La₃Zr₂O₁₂, LLZO), lithium phosphorus oxynitride (Li₃PO₄, LiPON), lithium super ionic conductor (LISICON), and lithium germanium sulfide (Li₄GeS₄, LGS). The cathode active material layer 212 is not meant to be particularly limited, but can include, for example, nickel manganese cobalt oxide (NMC), LFP, nickel cobalt aluminum oxide (NCA), nickel cobalt manganese aluminum oxide (NCMA), lithium manganese iron phosphate (LMFP), lithium manganese rich (LMR), lithium manganese oxide (LMO), and lithium nickel manganese oxide (LNMO).

In some embodiments, such as for sodium ion battery (SIB) applications, the cathode or anode active materials can include SIB active materials, such as layered- and tunnel-structured transition metal oxides, polyanion compounds, and prussian blue analogs (PBAs), hard carbon materials, such as petroleum coke or mesocarbon microbeads (MCMB), graphite, sodium titanates, such as Na₂Ti₃O₇ and Na_{0.44}MnO₂, tin-based compounds, such as SnO₂ and SnS₂, phosphorus-based compounds, such as phosphorus-carbon composites or phosphorus-based alloys, and combinations thereof.

Depending on battery construction (e.g., conventional vs. bi-polar current collectors, etc.) the separator 210 is optional but, if included, can be positioned to isolate they anode active material layer 208 and the cathode active material layer 212. The separator 210 can include dielectric materials such as, for example, polyethylene (PE), polypropylene (PP), polyethylene terephthalate (PET), and composites thereof, although other dielectrics are within the contemplated scope of this disclosure. In some embodiments, the separator 210 may include a thermally stable coating layer to improve shrinkage behavior (e.g., a porous ceramic coating or porous ester type polymer coating including, for example, polyimide, polyamide, polyimide-polyamide (PI/PA) copolymer, etc.).

As further shown in FIG. 2B, the battery cell 202 includes an electrolyte 216. In some embodiments, the electrolyte 216 is a liquid electrolyte that permeates, covers, and/or penetrates the cathode active material layer 212. In some embodiments, liquid electrolyte partially penetrates the separator 210 (as shown). In some embodiments, electrolyte 216 includes a lithium salt dissolved in a solvent.

In some embodiments, the solvent is an organic solvent. In some embodiments, the solvent includes a fluorinated diacyl acetamide. In some embodiments, the solvent includes a triflourodiacylacetamide. In some embodiments, the solvent includes N,N-Dimethyl-2,2,2-trifluoroacetamide (FDMA, refer to FIG. 4A). In some embodiments, the solvent includes N,N-Diethyl-2,2,2-trifluoroacetamide (FDEA, refer to FIG. 4B). The chemical structures of the fluorinated diacyl acetamides are discussed in greater detail with respect to FIG. 3.

Advantageously, the fluorinated diacyl acetamide solvents described previously are compatible with a range of lithium salts. Thus, the lithium salt chosen in the electrolyte 216 is not meant to be particularly limited and can vary depending on the needs of a given application. In some embodiments, for example, the lithium salt includes lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte 216 will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of the SEI layer on the lithium metal anode. In some embodiments, the lithium salts is formed to a concentration of 0.1 M to 2 M, for example, 0.8 M, although other concentrations are within the contemplated scope of this disclosure.

Some example electrolyte chemistries are now provided. In some embodiments, electrolyte 216 includes 1 M LiFSI and 0.2 M LiF₂BOB dissolved in FDMA. In some embodiments, electrolyte 216 includes 1 M LiFSI and 0.2 M LiF₂BOB dissolved in FDMA, and is free of carbonate solvents such as, for example, FEC, DMC, DEC, and/or EMC.

In some embodiments, electrolyte 216 includes 1 M LiF₂BOB and 0.2 M LiBF₄ dissolved in FDEA. In some embodiments, electrolyte 216 includes 1 M LiF₂BOB and 0.2 M LiBF₄ dissolved in FDEA, and is free of carbonate solvents such as, for example, FEC, DMC, DEC, and/or EMC.

In some embodiments, electrolyte 216 includes, in addition to the lithium salt and solvent, at least one additive. In some embodiments, the additive includes a carbonate solvent. The carbonate solvent can include, for example, FEC, DMC, DEC, and/or EMC. Advantageously, when present, the carbonate solvent content in electrolyte 216 is below 10 percent by weight. In some embodiments, the carbonate solvent content in electrolyte 216 is between 0.5 percent and 10 percent by weight. For example, in some embodiments, electrolyte 216 includes 1 M LiFSI and 0.2 M LiF₂BOB dissolved in FDMA with 2 percent by weight FEC. In some embodiments, electrolyte 216 includes 1 M LiF₂BOB and 0.2 M LiBF₄ dissolved in FDEA with 1 percent by weight FEC.

FIG. 3 illustrates the chemical structure 300 of a fluorinated diacyl acetamide for use as a solvent in an electrolyte (refer to FIG. 2B) in accordance with one or more embodiments. As shown in FIG. 3, the chemical structure 300 includes an N-acetyl group 302 coupled to three functional groups R₁, R₂, and R₃.

In some embodiments, the functional group R₁ includes a fluorocarbon. In some embodiments, the fluorocarbon includes, for example, CF₃, CF₂, CF, C₂F, C₂F₂, C₂F₃, C₂F₄, C₂F₅, or C₃F₇, although other fluorocarbons are possible and within the contemplated scope of this disclosure.

In some embodiments, the functional group R₂ includes an alkyl group. In some embodiments, the alkyl group includes, for example, a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃).

In some embodiments, the functional group R₃ includes an alkyl group. The alkyl group can be the same alkyl group, or a different alkyl group, as the functional group R₂. For example, in some embodiments, the functional group R₂ is a methyl group and the functional group R₃ is a methyl group. In some embodiments, the functional group R₂ is a methyl group and the functional group R₃ is an ethyl group. In some embodiments, the functional group R₂ is a methyl group and the functional group R₃ is an dodecyl group. All such combinations are possible and within the contemplated scope of this disclosure.

FIG. 4A illustrates the chemical structure 400 of a fluorinated diacyl acetamide (refer to FIG. 3) for use as a solvent in an electrolyte (refer to FIG. 2B) in accordance with one or more embodiments. As shown in FIG. 4A, the chemical structure 400 represents N,N-Dimethyl-2,2,2-trifluoroacetamide (FDMA) and includes an N-acetyl group 302 coupled to a first functional group R₁ that includes CF₃, a second functional group R₂ that includes an alkyl group, and a third functional group R₃ that includes an alkyl group (that is, the first functional group R₁ of FIG. 3 has been replaced with CF₃, the second functional group R₂ of FIG. 3 has been replaced with an alkyl group, and the third functional group R₃ of FIG. 3 has been replaced with an alkyl group). Advantageously, FDMA has a boiling point of 130 degrees Celsius and a melting point of 42 degrees Celsius. Consequently, lithium metal batteries having primarily FDMA-based electrolytes are more stable and suitable for wider operational windows (and at greater environmental tolerances) than lithium metal batteries having primarily carbonate-based electrolytes.

FIG. 4B illustrates the chemical structure 402 of a fluorinated diacyl acetamide (refer to FIG. 3) for use as a solvent in an electrolyte (refer to FIG. 2B) in accordance with one or more embodiments. As shown in FIG. 4B, the chemical structure 402 represents N,N-Diethyl-2,2,2-trifluoroacetamide (FDEA) and includes an N-acetyl group 302 coupled to a first functional group R₁ that includes CF₃, a second functional group R₂ that includes an ethyl group, and a third functional group R₃ that includes an ethyl group (that is, the first functional group R₁ of FIG. 3 has been replaced with CF₃, the second functional group R₂ of FIG. 3 has been replaced with an ethyl group, and the third functional group R₃ of FIG. 3 has been replaced with an ethyl group). Advantageously, FDEA has a boiling point of 160 degrees Celsius. Consequently, lithium metal batteries having primarily FDEA-based electrolytes are more stable and suitable for wider operational windows (and at greater environmental tolerances) than lithium metal batteries having primarily carbonate-based electrolytes.

FIG. 5A illustrates example chemistries for modifying ethers for different fluorination content in accordance with one or more embodiments. As discussed previously, lithium metal batteries described herein can include fluorinated diacyl acetamide-based electrolytes. In some embodiments, the fluorinated diacyl acetamide includes an N-acetyl group 302 coupled to three functional groups R₁, R₂, and R₃ (refer to FIG. 3). As shown in FIG. 5A, the first functional group R₁ can be synthesized according to known ether chemistries 500. Ethers are a class of compounds that contain an ether group—an oxygen atom connected to two organyl groups (e.g., alkyl, aryl, etc.). As further shown in FIG. 5A, ethers are of the general form R—O—R′, where R and R′ represent these organyl groups (again, alkyl groups, aryl groups, etc.), and can be synthesized via a combination of an alcohol (e.g., a hydroxymethyl group) and an organohalide.

FIGS. 5B, 5C, 5D, 5E, 5F, 5G, 5H, and 5I illustrate example ether compounds 502, 504, 506, 508, 510, 512, 514, and 516, respectively, having different fluorination content in accordance with one or more embodiments. As discussed previously, fluorinated diacyl acetamides can include an N-acetyl group 302 coupled to three functional groups R₁, R₂, and R₃ (refer to FIG. 3). In some embodiments, the first functional group R₁ can be synthesized according to known ether chemistries 500 (refer to FIG. 5A), depending on the desired fluorination content.

As shown in FIG. 5B, the ether compound 502 can include, for example, ethyl propyl ether. As shown in FIG. 5C, the ether compound 504 can include, for example, 2-Fluoroethyl Propyl Ether. As shown in FIG. 5D, the ether compound 506 can include, for example, 2,2-Difluoroethyl Propyl Ether. As shown in FIG. 5E, the ether compound 508 can include, for example, 2,2,2-Trifluoroethyl Propyl Ether. As shown in FIG. 5F, the ether compound 510 can include, for example, 1,1,2,2-Tetrafluoroethyl Propyl Ether. As shown in FIG. 5G, the ether compound 512 can include, for example, 2,2,3,3-Tetrafluoropropyl ethyl ether. As shown in FIG. 5H, the ether compound 514 can include, for example, 1,1,2,2-Tetrafluoroethyl 2,2,3,3-Tetrafluoropropyl Ether. As shown in FIG. 5I, the ether compound 516 can include, for example, 1,1,2,2-Tetrafluoroethyl 2,2,3,3,3-Pentafluoropropyl Ether.

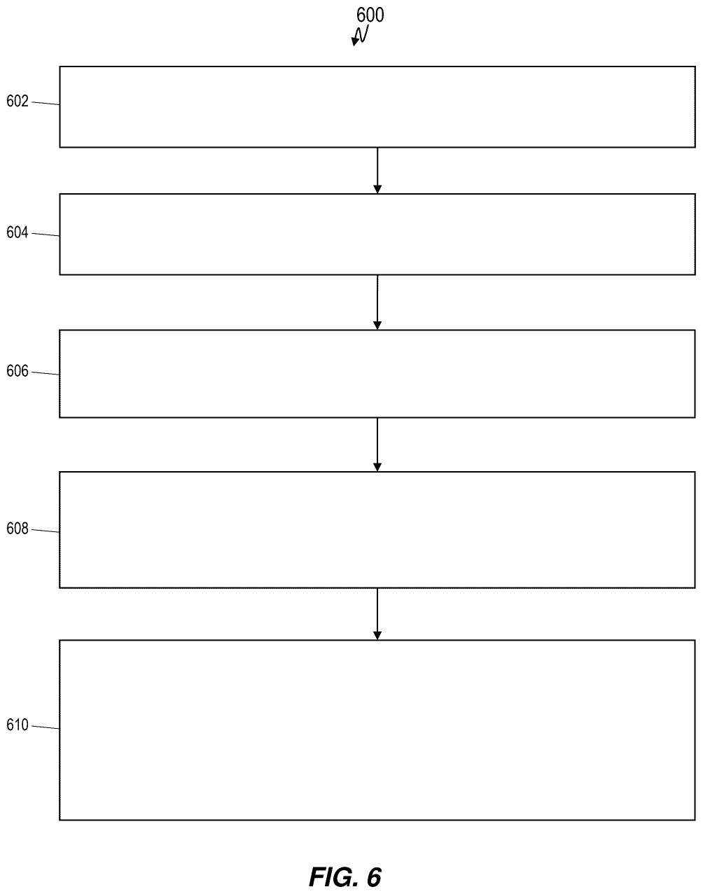

Referring now to FIG. 6, a flowchart 600 for leveraging fluorinated diacyl acetamides as the electrolyte solvent for lithium metal batteries is generally shown according to an embodiment. The flowchart 600 is described in reference to FIGS. 1-5I and may include additional steps not depicted in FIG. 6. Although depicted in a particular order, the blocks depicted in FIG. 6 can be rearranged, subdivided, and/or combined.

At block 602, the method includes forming an anode current collector.

At block 604, the method includes forming an anode active material layer in direct contact with a surface of the anode current collector.

At block 606, the method includes forming a cathode current collector.

At block 608, the method includes forming a cathode active material layer in direct contact with a surface of the cathode current collector.

At block 610, the method includes forming a liquid electrolyte over the cathode active material layer. In some embodiments, the liquid electrolyte includes a lithium salt dissolved in an organic solvent.

In some embodiments, the organic solvent includes a fluorinated diacyl acetamide having an N-acetyl group coupled to a first functional group, a second functional group, and a third functional group. In some embodiments, the fluorinated diacyl acetamide includes one of N,N-dimethyl-2,2,2-trifluoroacetamide (FDMA) or N,N-diethyl-2,2,2-trifluoroacetamide (FDEA).

In some embodiments, the lithium salt includes at least one of lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), or lithium bis(pentafluoroethanesulfonyl)imide (LiBETI).

In some embodiments, the first functional group includes a fluorocarbon of at least one of CF₃, CF₂, CF, C₂F, C₂F₂, C₂F₃, C₂F₄, C₂F₅, or C₃F₇.

In some embodiments, the second functional group and the third functional group each includes, separately, at least one of a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃). The second functional group and the third functional group can be the same functional group, or alternatively, different functional groups.

In some embodiments, the method includes forming a separator between the anode active material layer and the cathode active material layer. In s the liquid electrolyte partially penetrates the separator.

In some embodiments, the liquid electrolyte further includes a carbonate solvent having a concentration in the electrolyte of less than 10 percent by weight. In some embodiments, concentration of the carbonate solvent is 2 percent by weight. Alternatively, in some embodiments, the liquid electrolyte is free of carbonate solvents.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
an anode current collector;
an anode active material layer in direct contact with a surface of the anode current collector;
a cathode current collector;
a cathode active material layer in direct contact with a surface of the cathode current collector; and
a liquid electrolyte over the cathode active material layer, the liquid electrolyte comprising a lithium salt dissolved in an organic solvent;
wherein the organic solvent comprises a fluorinated diacyl acetamide comprising an N-acetyl group coupled to a first functional group, a second functional group, and a third functional group.

2. The vehicle of claim 1, wherein the fluorinated diacyl acetamide comprises one of N,N-dimethyl-2,2,2-trifluoroacetamide (FDMA) or N,N-diethyl-2,2,2-trifluoroacetamide (FDEA).

3. The vehicle of claim 2, wherein the lithium salt comprises at least one of lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), or lithium bis(pentafluoroethanesulfonyl)imide (LiBETI).

4. The vehicle of claim 1, wherein the first functional group comprises a fluorocarbon comprising at least one of CF₃, CF₂, CF, C₂F, C₂F₂, C₂F₃, C₂F₄, C₂F₅, or C₃F₇, and wherein the second functional group and the third functional group each comprises, separately, at least one of a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃).

5. The vehicle of claim 1, further comprising a separator between the anode active material layer and the cathode active material layer.

6. The vehicle of claim 5, wherein the liquid electrolyte partially penetrates the separator.

7. The vehicle of claim 1, wherein the liquid electrolyte further comprises a carbonate solvent having a concentration in the electrolyte of less than 10 percent by weight.

8. A battery cell comprising:
an anode current collector;
an anode active material layer in direct contact with a surface of the anode current collector;
a cathode current collector;
a cathode active material layer in direct contact with a surface of the cathode current collector; and
a liquid electrolyte over the cathode active material layer, the liquid electrolyte comprising a lithium salt dissolved in an organic solvent;
wherein the organic solvent comprises a fluorinated diacyl acetamide comprising an N-acetyl group coupled to a first functional group, a second functional group, and a third functional group.

9. The battery cell of claim 8, wherein the fluorinated diacyl acetamide comprises one of N,N-dimethyl-2,2,2-trifluoroacetamide (FDMA) or N,N-diethyl-2,2,2-trifluoroacetamide (FDEA).

10. The battery cell of claim 9, wherein the lithium salt comprises at least one of lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), or lithium bis(pentafluoroethanesulfonyl)imide (LiBETI).

11. The battery cell of claim 8, wherein the first functional group comprises a fluorocarbon comprising at least one of CF₃, CF₂, CF, C₂F, C₂F₂, C₂F₃, C₂F₄, C₂F₅, or C₃F₇, and wherein the second functional group and the third functional group each comprises, separately, at least one of a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃).

12. The battery cell of claim 8, further comprising a separator between the anode active material layer and the cathode active material layer.

13. The battery cell of claim 12, wherein the liquid electrolyte partially penetrates the separator.

14. The battery cell of claim 8, wherein the liquid electrolyte further comprises a carbonate solvent having a concentration in the liquid electrolyte of less than 10 percent by weight.

15. A method comprising:
forming an anode current collector;
forming an anode active material layer in direct contact with a surface of the anode current collector;
forming a cathode current collector;
forming a cathode active material layer in direct contact with a surface of the cathode current collector; and
forming a liquid electrolyte over the cathode active material layer, the liquid electrolyte comprising a lithium salt dissolved in an organic solvent;
wherein the organic solvent comprises a fluorinated diacyl acetamide comprising an N-acetyl group coupled to a first functional group, a second functional group, and a third functional group.

16. The method of claim 15, wherein the fluorinated diacyl acetamide comprises one of N,N-dimethyl-2,2,2-trifluoroacetamide (FDMA) or N,N-diethyl-2,2,2-trifluoroacetamide (FDEA).

17. The method of claim 16, wherein the lithium salt comprises at least one of lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), or lithium bis(pentafluoroethanesulfonyl)imide (LiBETI).

18. The method of claim 15, wherein the first functional group comprises a fluorocarbon comprising at least one of CF₃, CF₂, CF, C₂F, C₂F₂, C₂F₃, C₂F₄, C₂F₅, or C₃F₇, and wherein the second functional group and the third functional group each comprises, separately, at least one of a methyl group (—CH₃), an ethyl group (—CH₂CH₃), a propyl group (—CH₂CH₂CH₃), an isopropyl group (—CH(CH₃)₂), a butyl group (—CH₂CH₂CH₂CH₃), a sec-butyl group (—CH(CH₃)CH₂CH₃), a tert-butyl group (—C(CH₃)₃), an isobutyl group (—CH₂CH(CH₃)₂), a pentyl group (—CH₂CH₂CH₂CH₂CH₃), an isopentyl group (—CH₂CH(CH₃)CH₂CH₃), a neopentyl group (—C(CH₃)₂CH₂CH₃), a hexyl group (—CH₂CH₂CH₂CH₂CH₂CH₃), a 2-methylpentyl group (—CH₂CH(CH₃)CH₂CH₂CH₃), a 3-methylpentyl group (—CH(CH₃)CH₂CH₂CH₂CH₃), a 2,2-dimethylbutyl group (—C(CH₃)₂CH₂CH₂CH₃), a 2,3-dimethylbutyl group (—CH(CH₃)CH(CH₃)CH₂CH₃), a heptyl group (—CH₂CH₂CH₂CH₂CH₂CH₂CH₃), an octyl group (—CH₂CH₂CH₂CH₂CH₂CH₂CH₂CH₃), a nonyl group (—CH₂CH₂CH₂CH₂CH₂CH₂CH₂CH₂CH₃), a decyl group (—CH₂CH₂CH₂CH₂CH₂CH₂CH₂CH₂CH₂CH₃), an undecyl group (—CH₂CH₂CH₂CH₂CH₂CH₂CH₂CH₂CH₂CH₂CH₃), or a dodecyl group (—CH₂CH₂CH₂CH₂CH₂CH₂CH₂CH₂CH₂CH₂CH₂CH₃).

19. The method of claim 15, further comprising a separator between the anode active material layer and the cathode active material layer, wherein the liquid electrolyte partially penetrates the separator.

20. The method of claim 15, wherein the liquid electrolyte further comprises a carbonate solvent having a concentration in the liquid electrolyte of less than 10 percent by weight.
